(19) United States
(12) Patent Application Publication
(10) Pub. No.: US 2006/0062229 A1
(43) Pub. Date: Mar. 23, 2006

(54) Terminal adapter device capable of performing IEEE1394-to-Ethernet conversion

(75) Inventors: Myung-Sop Lee, Gumi-si (KR); Gu-Young Kang, Gumi-si (KR); Jin-Han Kim, Gumi-si (KR); Yeong-Seop Lee, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/202,504

(22) Filed: Aug. 12, 2005

(30) Foreign Application Priority Data
Nov. 30, 2004 (KR) 2004-99435
Sep. 21, 2004 (KR) 2004-75528

(51) Int. Cl. H04L 12/28

(52) U.S. Cl. 370/401

(57) ABSTRACT

Disclosed is a terminal adapter device to enable an IEEE1394-to-Ethernet conversion for processing by hardware data of an Ethernet standard that is inputted/outputted in a home network system based on an IEEE 1394. The terminal adapter device includes a 1394 unit to perform an IEEE 1394 connection with a home gateway unit, connected to a network such as a Wide Area Network (WAN), to process data of the network system, and with an external IEEE 1394 client, an Ethernet unit to perform an Ethernet connection with an external Ethernet client, an Ethernet/1394 conversion unit, connected to the 1394 unit and the Ethernet unit, to perform a protocol conversion, and a control unit to control the protocol conversion.

### CLAIM OF PRIORITY

This application claims priority to an application entitled “Terminal Adapter Device Capable of Performing IEEE1394-to-Ethernet Conversion,” filed in the Korean Intellectual Property Office on Sep. 21, 2004 and assigned Serial No. 2004-75528, the entire contents of which are hereby incorporated by reference.

### BACKGROUND OF THE INVENTION

1. Field of the Invention

The present invention relates generally to a home network system, and more particularly to a protocol conversion device for supporting both IEEE 1394 and Ethernet.

2. Description of the Related Art

Ethernet is a network announced by Metcalf and Boggs of Xerox PARC in 1976. It provides a communication function that enables data transmission between a user appliance and a computer located within a particular distance. With the development of the Internet, the Ethernet has widely been used.

Meanwhile, IEEE 1394 is a widely used protocol that simultaneously transmits real-time data such as broadcasting data and asynchronous data such as Internet data. IEEE has a maximum speed of 400 Mbps and a maximum transmission distance of 100 m. Recently, by utilizing Internet protocol (IP) over 1394 technology, IP data can be transmitted through IEEE 1394 Link Layer Controller (LLC) and Physical Layer (PHY) instead of an Ethernet link layer. Thus, IEEE 1394 is now widely used for Internet data transmission.

The IP over 1394 technology for transmitting IP data in the IEEE 1394 was registered as an RFC 2734 standard protocol in 1999. It provides a protocol conversion method, a data structure, an address resolution protocol (ARP) method, etc. These are required for the transmission of IP version 4 (IPv4) datagram in a system adopting the IEEE 1394 as a physical layer.

FIG. 1 is a view illustrating a general IEEE 1394 software stack.

Referring to FIG. 1, the IEEE 1394 software stack is composed of an IEEE 1394 applications for an IEEE 1394 application layer, an RTOS (Real-Time Operating System) including a transaction layer, and an embedded CPU including a link layer and a physical layer.

Specifically, the IEEE 1394 applications for the IEEE 1394 application layer have software 101 for application devices such as a CD-ROM, hard disk drive, printer, scanner, etc. The RTOS is for securing outputs within a determined time limit. It is composed of an IP over 1394 102 for connection with IP data, an Serial Bus Protocol-2 (SBP-2) 103 for a serial bus connection, an IEEE 1394 serial bus manager 104 for an IEEE 1394 serial bus management, and an IEEE 1394 link driver 105 for connection with a link layer. The embedded CPU has an IEEE 1394 link core 106 and an IEEE 1394 physical core 107.

The software stack as described above, in comparison to Ethernet optimized to an IP protocol, has several processes that include IP packet fragmentation and assembling processes and are added to the IP over 1394 process. Consequently, even if a microprocessor system is used, its softwired operational performance is low under the same process power in comparison to the system simply using an Ethernet protocol.

### SUMMARY OF THE INVENTION

One aspect of the present invention is to provide a terminal adapter device capable of performing an IEEE1394-to-Ethernet conversion to process by hardware data an Ethernet standard that is input/output in a home network system based on an IEEE 1394.

It is another aspect of the present invention to provide a terminal adapter device capable of performing an IEEE1394-to-Ethernet conversion to improve the performance and reduce the burden of a central processing unit (CPU) by constructing by hardware a part of the IP processing function of an IEEE 1394 that is processed by software.

In accordance with the principles of the present invention a terminal adapter device is provided of an IEEE1394-based network system to enable an IEEE1394-to-Ethernet conversion. The terminal adapter device includes a 1394 unit to perform an IEEE 1394 connection with a gateway unit, connected to a network such as a Wide Area Network (WAN), to process data of the network system and an external IEEE 1394 client, an Ethernet unit to perform an Ethernet connection with an external Ethernet client, an Ethernet/1394 conversion unit, connected to the 1394 unit and the Ethernet unit, to perform a protocol conversion, and a control unit to control the protocol conversion.

### BRIEF DESCRIPTION OF THE DRAWINGS

The present invention will be more apparent from the following detailed description taken in conjunction with the accompanying drawings, in which:

FIG. 1 is a view illustrating a general IEEE 1394 software stack;

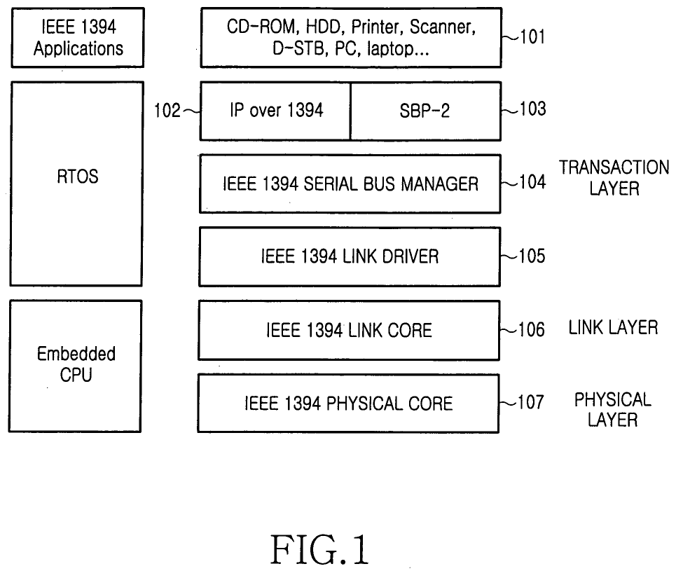

FIG. 2 is a block diagram illustrating an IEEE 1394 home network system that includes a terminal adapter device according to the present invention; and

FIG. 3 is a block diagram illustrating the an Ethernet/1394 conversion unit in the terminal adapter device according to the present invention.

### DETAILED DESCRIPTION

Embodiments of the present invention will be described in detail hereinafter with reference to the accompanying drawings. In the following description of the present invention, the same drawing reference numerals are used for the same elements even in different drawings. For the purposes of clarity and simplicity, a detailed description of known functions and configurations incorporated herein will be omitted as it may obscure the subject matter of the present invention.

One advantage of an IEEE1394-based home network system is that it can simultaneously transmit isochronous data such as A/V (Audio/Video) data and asynchronous data such as an IP packet. Further, a terminal may have a different type of protocol from the IEEE 1394. The present invention provides a terminal adapter device for supporting such a terminal having a different type of protocol from the IEEE 1394.

Generally, an IP terminal has a mounted Ethernet port, and an A/V appliance has a mounted IEEE 1394 port. In the embodiment of the present invention, the terminal adapter device can receive data through an IEEE 1394 protocol of the home network system, and serve the data with at least two standards. For example, an Ethernet protocol and the IEEE 1394 protocol.

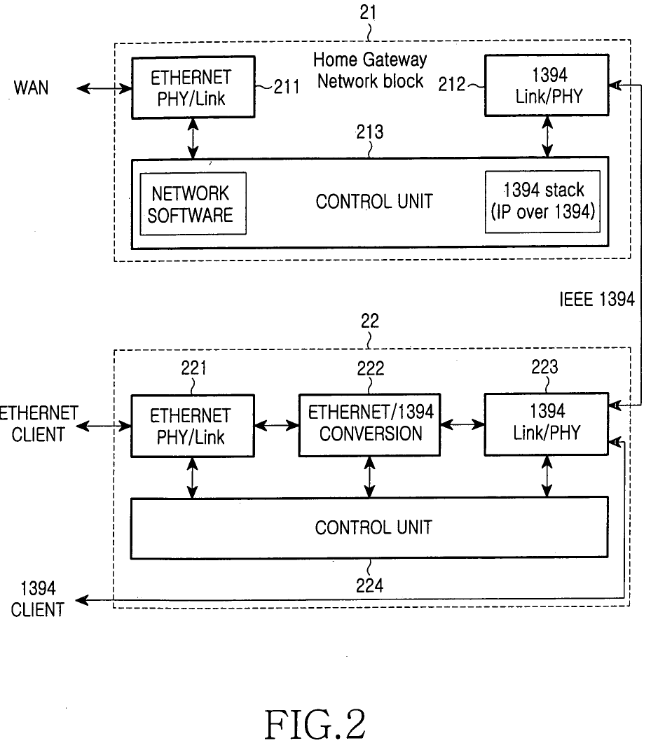

FIG. 2 is a block diagram illustrating the construction of the IEEE 1394 home network system that includes the terminal adapter device according to the present invention.

As illustrated in FIG. 2, the IEEE 1394 home network system including the terminal adapter device according to the present invention includes (1) a home gateway block/unit 21, connected to a first network such as a Wide Area Network (WAN), for processing (uplink/downlink) data of the home network system; and (2) the terminal adapter device 22, connected by the IEEE 1394 to the home gateway block 21, for processing data through an IEEE 1394 client (i.e., a terminal) or an Ethernet client (i.e., terminal).

The home gateway block 21 includes (1) an Ethernet unit 211 (e.g. an Ethernet PHY/link unit) for performing an Ethernet connection with the WAN; (2) a 1394 unit 212 (e.g. an 1394 link/PHY unit) for performing an IEEE 1394 connection in the home network system; and (3) a control unit 213, connected to the Ethernet PHY/link unit 211 and the 1394 link/PHY unit 212. The control unit 213 is provided with a 1394 stack for an IP over 1394 function for an IEEE1394-Ethernet connection and network software for networking through the Ethernet, for controlling operations according to respective protocols.

The terminal adapter device 22 includes a 1394 link/PHY unit 223, an Ethernet/1394 conversion unit 222, an Ethernet PHY/link unit 221 and a control unit 224. The 1394 link/PHY unit 223 performs an IEEE 1394 connection with the home gateway block 21 and an external IEEE 1394 client and transferring data to be transmitted to the Ethernet client to the Ethernet/1394 conversion unit 222 under the control of a control unit 224. The Ethernet PHY/link unit 221 performs an Ethernet connection with the Ethernet client, the Ethernet/1394 conversion unit 222, connected to the 1394 link/PHY unit 223 and the Ethernet PHY/link unit 221, and performs a protocol conversion under the control of the control unit 224. The control unit 224 controls internal function blocks of the terminal adapter device 22.

Particularly, the control unit 224 controls the 1394 link/PHY unit 223, the Ethernet PHY/link unit 221 and the Ethernet/1394 conversion unit 222 to interwork with one another.

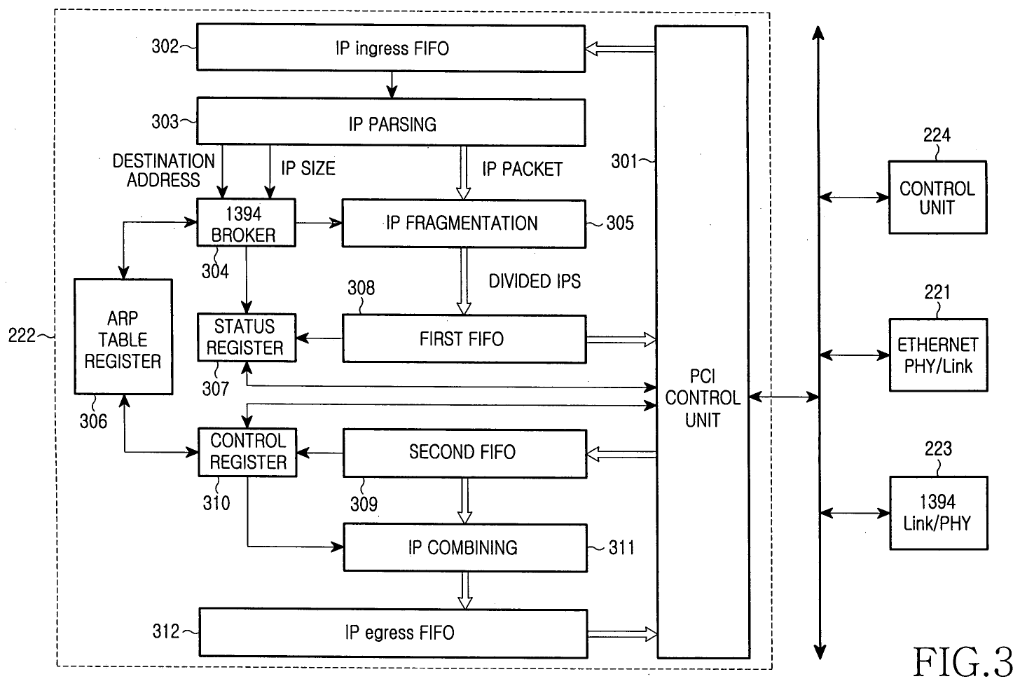

FIG. 3 is a block diagram illustrating the Ethernet/1394 conversion unit in the terminal adapter device according to the present invention.

Referring to FIG. 3, the Ethernet/1394 conversion unit 222 includes an Ethernet-to-1394 conversion unit, a 1394-to-Ethernet conversion unit, an Address Resolution Protocol (ARP) table register, and a PCI control unit 301.

The Ethernet/1394 conversion unit 222 may be composed of a Field-Programmable Gate Array (FPGA), and includes (1) an IP ingress First In First Out (FIFO) buffer 302 for buffering and transferring an input IP packet from the Ethernet PHY/link unit 221 so as to perform an IEEE 1394 packetizing of the input IP packet; (2) an IP parsing unit 303 for parsing the IP packet transferred from the IP ingress FIFO buffer 302; (3) a 1394 broker 304 for receiving an IP destination address and IP size information parsed by the parsing unit 303 and controlling division of the corresponding IP packet to meet with an IEEE 1394 form; (4) an IP fragmentation unit 305 for dividing the IP packet transferred from the IP parsing unit 303 under the control of the 1394 broker 304; (5) a status register 307 for controlling an access timing of an output of the divided IP packets under the control of the 1394 broker 304 and (6) a PCI control unit 301, and (7) a first FIFO unit 308 for receiving the divided IP packets from the IP fragmentation unit 305 and outputting the received IP packets to the 1394 link/PHY unit 223 under the control of the status register 307.

The 1394-to-Ethernet conversion unit includes (1) a second FIFO unit 309 for storing the IEEE 1394 packets transferred from the 1394 link/PHY unit 223; (2) a control register 310, connected to the second FIFO unit 309, for outputting a control signal for performing an IP packetizing of the transferred IEEE 1394 packets; (3) an IP combining unit 311 for combining the IEEE 1394 packets transferred from the second FIFO unit 309 into one IP packet under the control of the control register 310; and (4) an IP egress FIFO unit 312 for storing and outputting the combined IP packet to the Ethernet PHY/link unit 221.

The ARP table register 306 is connected to the 1394 broker 304 and the control register 310. It constructs an ARP table for mapping a node ID of the IEEE 1394 packet on an IP address of an Ethernet packet.

The PCI control unit 301 is connected to the control unit 224, the Ethernet PHY/link unit 221 and the 1394 link/PHY unit 223. It provides a data transmission path for an interface with an outside.

The process of the Ethernet packet and the IEEE 1394 packet performed by the above-described construction will now be explained.

First, the ARP table is constructed. Primarily, the IEEE 1394 ARP table is produced when IEEE 1394 bus reset occurs as an appliance that intends to receive the IP packet through an IEEE 1394 port is connected. However, in the embodiment of the present invention, as illustrated in the drawings, a seamless conversion/transmission of IP packets to Ethernet is performed. Thus the terminal adapter device 22 does not have an IP address. Accordingly, if an IP client is connected to the Ethernet PHY/link unit 221, (the Ethernet port of the terminal adapter device 22) the IP address of the IP client is transferred to the home gateway network block 21. This is performed by the control unit 224. The home gateway network block 21 recognizes the connection of the IP appliance to a lower cluster based on the IP information and updates the ARP table accordingly. The updated information is again transferred to the terminal adapter device 22 to be shared through the Ethernet/1394 conversion unit 222.

The IEEE 1394 packetizing operation of the IP packet will now be explained.

Once the ARP table is produced or updated, it is required to store the produced or updated ARP table in the Ethernet/1394 conversion unit 222. If the ARP table is stored, the IEEE 1394 packetizing operation of the IP packet is enabled (i.e., is in an enable mode).

The IP packet transferred from the Ethernet client is input to the Ethernet/1394 conversion unit 222 through the Ethernet PHY/link 221. Then it is stored in the IP ingress FIFO unit 302.

The stored IP packet is input to and parsed by the IP parsing unit 303. The necessary IP information including the destination address of the IP packet and the size of the IP packet is obtained from the IP parsing unit 303.

The IP information obtained through the IP parsing unit 303 is input to the 1394 broker 304. The 1394 broker 340 determines how many parts it divides the IP packet into by comparing speed information of the presently set IEEE 1394 transmission line with the IP size. Thereafter, it instructs the IP fragmentation unit 305 to divide the IP packet. Additionally, the 1394 broker 304 extracts the 1394 node ID mapped in the ARP table and registers the extracted 1394 node ID in the status register 307 (so that the control unit 224 can refer to the 1394 node ID). Since the 1394 broker 304 can recognize the broadcasting/unicasting status in the IEEE 1394 bus through the IP destination address, it determines whether to transmit the generated IEEE 1394 packet as an asynchronous block for the unicasting or as an asynchronous stream for the broadcasting. It also registers the determined status information in the status register 307.

Meanwhile, the IP packets divided through the IP fragmentation unit 305 are numbered by the IP fragmentation unit 305, transferred and stored in order in the first FIFO unit 308. Once the storage of the numbered IP packets is completed, the IEEE 1394 packets are transferred to the status register 307. The status register 307 reports the transfer of the IP packets to the control unit 224. The 1394 link/PHY 223 sequentially receives the IEEE 1394 packets from the first FIFO unit 308 through the PCI control unit 301 under the control of the control unit 224.

The IP packetizing operation of the IEEE 1394 packet will now be explained.

Once the divided IP packets are received from the 1394 link/PHY unit 223 through the second FIFO unit 309, the second FIFO unit 309 transfers this information to the control register 310. The control register 310 controls the IP combining unit 311 to reassemble the IP packets stored in the second FIFO unit 309. The IP packets are reassembled in the order of their numbers at the time of fragmentation in synchronization with the node ID that means the last number of one completed IP packet so that the divided IP packets inputted in order constitute one complete IP packet.

Once the reassembling of the IP packets is completed in the IP combining unit 311, the reassembled IP packet is stored in the IP egress FIFO unit 312. It is also reported to the control unit 224 so that the complete IP packet can be read by the Ethernet/link unit 221.

As described above, according to the present invention, the operation on the software stack such as the IP over 1394 is hardwired. Consequently, the load of the CPU is reduced. Additionally, by reducing the load of the CPU, the system can be implemented using a low-priced CPU.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A terminal adapter device of an IEEE1394-based network system, the device comprising:
a 1394 unit to perform an IEEE 1394 connection with a gateway unit, connected to a first network, for processing data of the network system and an external IEEE 1394 client;
an Ethernet unit to perform an Ethernet connection with an external Ethernet client;
an Ethernet/1394 conversion unit, connected to the 1394 unit and the Ethernet unit, to perform a protocol conversion; and
a control unit to control the protocol conversion.

2. The terminal adapter device as claimed in claim 1, wherein the 1394 unit is a 1394 link/PHY (Physical) unit.

3. The terminal adapter device as claimed in claim 1, wherein the Ethernet unit is a Ethernet link/PHY unit.

4. The terminal adapter device as claimed in claim 1, wherein the first network is a Wide Area Network.

5. The terminal adapter device as claimed in claim 1, wherein the Ethernet/1394 conversion unit comprises:
an IEEE 1394 packetizing unit to receive an IP packet and perform an IEEE 1394 packetizing of the received IP packet;
an Ethernet packetizing unit to receive the IEEE1394-packetized IP packets and output a complete IP packet;
an address resolution protocol (ARP) table register for constructing an ARP table; and
a PCI control unit, connected to the control unit, the Ethernet unit and the 1394 unit, to provide a data transmission path for an interface with an outside.

6. The terminal adapter device as claimed in claim 2, wherein the ARP table maps node IDs of IEEE 1394 packets on IP addresses of Ethernet packets.

7. The terminal adapter device as claimed in claim 5, wherein the IEEE 1394 packetizing unit comprises:
a buffer to buffer and transferr an input IP packet from the Ethernet unit;
a parsing unit to parse the IP packet from the buffer;
a 1394 broker to receive an IP destination address and IP size information from the parsing unit and control division of the corresponding IP packet to an IEEE 1394 form;
an fragmentation unit to divide the IP packet from the parsing unit;
a status register to control access timing of the divided IP packets; and
a first buffer unit to receiving the divided IP packets from the IP fragmentation unit and output the received IP packets to the 1394 unit.

8. The terminal adapter device as claimed in claim 7, wherein the buffer is an ingress First In First Out (FIFO) buffer.

9. The terminal adapter device as claimed in claim 8, wherein the first buffer unit is a First In First Out (FIFO) buffer unit.

10. The terminal adapter device as claimed in claim 7, wherein the 1394 broker uses a broadcasting/unicasting status in the IEEE 1394 bus by the input IP destination address, and determines whether to transmit the generated IEEE 1394 packet as an asynchronous block for the unicasting or as an asynchronous stream for the broadcasting to register the determined status information in the status register.

11. The terminal adapter device as claimed in claim 8, wherein the Ethernet packetizing unit comprises:
a second FIFO unit to store the divided IP packets;
a control register, connected to the second FIFO unit, to output a control signal for combining the divided IP packets;
an IP combining unit to combine the divided IP packet transferred from the second FIFO unit into one IP packet; and
an IP egress FIFO unit to store and output the combined IP packet to the Ethernet unit.
